(19) United States
(12) Patent Application Publication
(10) Pub. No.: US 2011/0265900 A1
(43) Pub. Date: Nov. 3, 2011

(54) INFLATING VALVE FOR AN INFLATABLE OBJECT

(76) Inventor: Chun-Chung TSAI, Dongguan (CN)

(21) Appl. No.: 12/770,223

(22) Filed: Apr. 29, 2010

(51) Int. Cl. F16K 15/20; F16K 15/14

(52) U.S. Cl. 137/857

(57) ABSTRACT

An inflating valve for an inflatable object has a body, a valve disk, a cap and a recoil member. The body is body and has a passage and a disk mount. The passage is defined through the body and has a bottom opening. The valve disk is attached securely to the bottom of the body to close the bottom opening of the passage and has a mounting end and a free end. The mounting end is mounted securely on the disk mount of the body. The free end is opposite to the mounting end. The cap is attached to the body around the bottom opening and holds the valve disk inside. The recoil member is mounted between the valve disk and the cap to push the valve disk closing the bottom opening of the passage in the body.

### BACKGROUND OF THE INVENTION

1. Field of the Invention The present invention relates to an inflating valve, and more particularly to an inflating valve that can close a passage automatically.

2. Description of Related Art

An inflatable object, such as a swim ring, a pneumatic boat, an inflating toy or furniture has to be inflated for use. To inflate an object, the inflatable object is connected to a pressured air source via an inflating valve that is mounted on the object. The conventional inflating valve has a valve disk closing a passage in the inflating valve to keep air in the object from leaking. When the object is inflated, the valve disk is pushed away from the passage manually to allow the pressured air to be led into and inflate the object.

However, after the object is completely inflated, the valve disk on the conventional inflating valve has also to be moved to the closing condition manually. This will cause trouble and inconvenience of operation of the conventional inflating valve.

To overcome the shortcomings, the present invention tends to provide an inflating valve to mitigate or obviate the aforementioned problems.

### SUMMARY OF THE INVENTION

The main objective of the invention is to provide an inflating valve that can close a passage automatically.

The inflating valve has a body, a valve disk, a cap and a recoil member. The body is body and has a bottom, a passage and a disk mount. The passage is defined through the body and has a bottom opening defined in the bottom of the body. The disk mount is formed on the bottom of the body. The valve disk is attached securely to the bottom of the body to close the bottom opening of the passage and has a mounting end and a free end. The mounting end is mounted securely on the disk mount of the body. The free end is opposite to the mounting end. The cap is attached to the body around the bottom opening and holds the valve disk inside. The recoil member is mounted between the valve disk and the cap to push the valve disk closing the bottom opening of the passage in the body.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an inflating valve in accordance with the present invention;

FIG. 2 is an exploded perspective view of the inflating valve in FIG. 1;

FIG. 3 is a side view in partial section of the inflating valve in FIG. 1 in a closing condition connected to a pressured air source; and

FIG. 4 is an operational side view in partial section of the inflating valve in FIG. 3 in an inflating condition.

### DETAILED DESCRIPTION OF PREFERRED EMBODIMENT

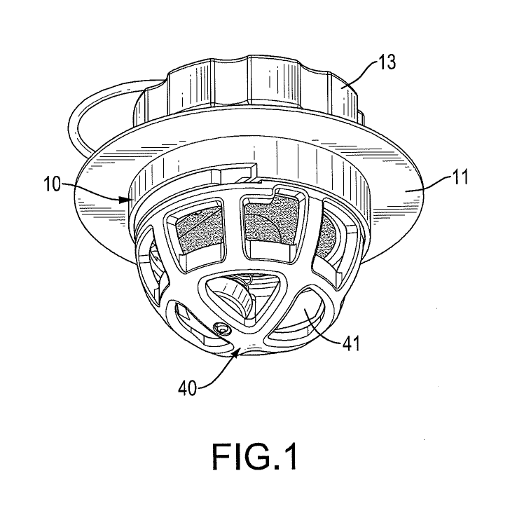

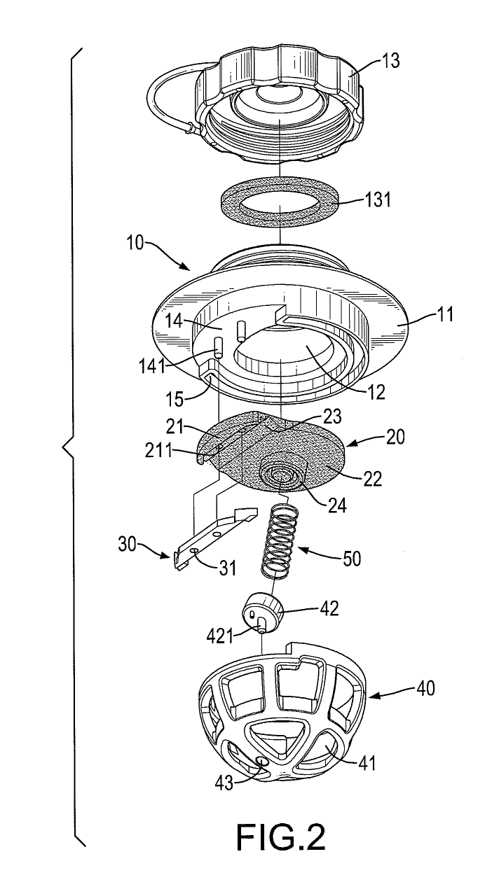

With reference to FIGS. 1 to 3, an inflating valve for an inflatable object in accordance with the present invention comprises a body (10), a cover (13), a valve disk (20), a fixing element (30), a cap (40) and a recoil member (50).

The body (10) is hollow, may be tubular and has an outer surface, a passage (12), a disk mount (14), an annular flange (11) and a curved recess (15). The passage (12) is defined through the body (10) and has a bottom opening defined in the bottom of the body (10) and a top opening defined in the top of the body (10). The disk mount (14) is formed on the bottom of the body (10), extends partially into the bottom opening and has at least one mounting post (141) formed on and protruding from the disk mount (14). Preferably, two mounting posts (141) are implemented. The annular flange (11) is formed around and protrudes from the outer surface of the body (10) and is connected to the inflatable object. The curved recess (15) is formed in the bottom of the body (10).

The cover (13) is mounted on the top of the body (10) in a thread manner. Preferably, the body (10) has an outer thread formed on the outer surface around the top opening, and the cover (13) has an inner thread engaging the outer thread on the body (10). The cover (13) further has an O-ring (121) mounted in the cover (10) and around the top opening of the body (10) to provide a sealing effect to the top opening of the body (10).

The valve disk (20) is rubber, is attached securely to the bottom of the body (10) with the fixing element (30) to close the bottom opening of the passage (12) and has a mounting end (21), a free end (22) and a bending groove (23). The mounting end (21) is mounted securely on the disk mount (14) of the body (10) and has at least one mounting hole (211). Preferably, two mounting holes (211) are implemented. The mounting holes (211) are defined through the mounting end (21) of the valve disk (20) and are mounted respectively around the mounting posts (141) on the body (10) to attach the mounting end (21) of the valve disk (20) onto the disk mount (14) on the body (10). The free end (22) is opposite to the mounting end (21). The bending groove (23) is defined in a side face of the valve disk (20) opposite to the bottom of the body (10) and is adjacent to the mounting end (21) to make the valve disk (20) bendable at the bending groove (23).

The fixing element (30) is attached to the bottom of the body (10) to mount the valve disk (20) on the disk mount (14) and to squeeze the mounting end (21) of the valve disk (20) between the disk mount (14) and the fixing element (30). The fixing element (30) has at least one mounting hole (31) mounted respectively around the at least one mounting post (141) on the disk mount (14) of the body (10). Preferably, two mounting holes (31) are implemented. Each mounting post (141) is mounted through the corresponding mounting holes (211,31) in the valve disk (20) and the fixing element (30) in sequence.

The cap (40) is attached to the body (10) around the bottom opening, is contained in the inflatable object, holds the valve disk (20) inside and has a top, a curved edge and multiple vents (41). The curved edge is formed on and protrudes from the top of the cap (40) and is mounted securely in the curved recess (15) in the body (10) to attach the cap (40) securely to the body (10). The vents (41) are defined through the cap (40) to allow pressured air entering into the inflatable object via the vents (41).

The recoil member (50) may be a spring, is mounted between the valve disk (20) and the cap (40) to push the valve disk (20) closing the bottom opening of the passage (12) in the body (10). In addition, the valve disk (20) further has a first spring mount (24) formed on the bottom of the valve disk (20), and the cap (40) further has a second spring mount (42) mounted on and protruding from the inner surface of the cap (40). The recoil member (50) has two ends respectively connected securely to the first and second spring mounts (24,42) on the valve disk (20) and the cap (40). Preferably, the second spring mount (42) is mounted detachably on the cap (40). The cap has a pin hole (43) defined in the cap (40). The second spring mount (42) has a mounting pin (421) formed on and protruding from the bottom of the second spring mount (42) and inserted securely into the pin hole (43) in the cap (40). Additionally, each spring mount (24,42) has an annular groove (241,422) defined in an end of the spring mount (24,42) to hold one end of the recoil member (50) inside.

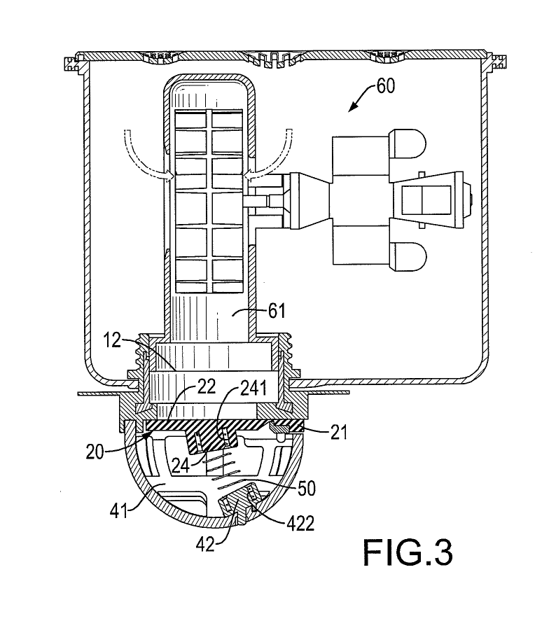

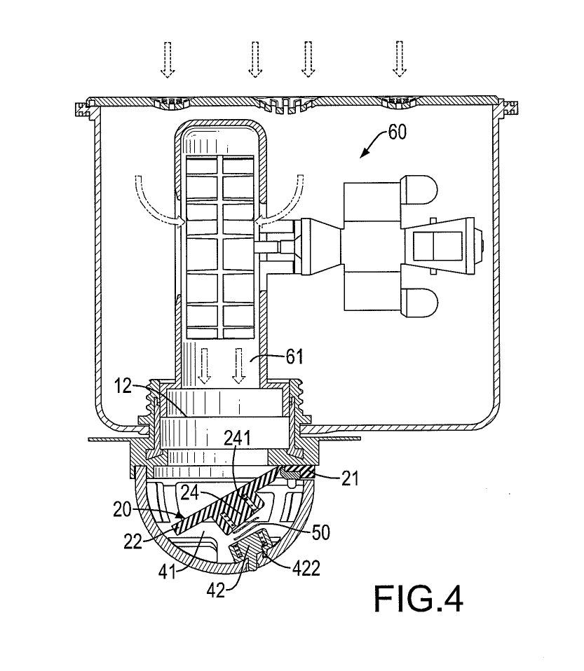

To inflate an inflatable object, with reference to FIGS. 3 and 4, the cover (13) is detached from the body (10) to open the top opening, and the body (10) is connected to a pressured air source (60) having a connector (61). The connector (61) is inserted into the passage (12) of the body (10) via the top opening, such that pressured air can be led into the passage (12) via the connector (61) to push the free end (22) of the valve disk (20) away from the bottom opening. Accordingly, the pressured air can enter into the object via the vents (41) in the cap (40) to inflate the object. At this time, the recoil member (50) is compressed.

After the object is completely inflated, the pressured air source is closed, and the valve disk (20) can be automatically moved/pivoted to the closing condition as shown in FIG. 3 by recoil force provided by the recoil member (50). Therefore, to open or close the valve disk from the bottom opening is automatic but not manual, the operation of the inflating valve is easy and convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An inflating valve for an inflating object comprising:
a hollow body having
a bottom;
a passage defined through the body and having a bottom opening defined in the bottom of the body; and
a disk mount formed on the bottom of the body;
a valve disk attached securely to the bottom of the body to close the bottom opening of the passage and having
a mounting end mounted securely on the disk mount of the body; and
a free end opposite to the mounting end;
a cap attached to the body around the bottom opening and holding the valve disk inside; and
a recoil member mounted between the valve disk and the cap to push the valve disk closing the bottom opening of the passage in the body.

2. The inflating valve as claimed in claim 1, wherein
the body is tubular and further has
an annular flange formed around and protruding from an outer surface of the body; and
a curved recess formed in the bottom of the body;
the passage further has a top opening defined in a top of the body; and
the cap has a curved edge formed on and protruding from a top of the cap and mounted securely in the curved recess in the body.

3. The inflating valve as claimed in claim 2 further comprising a cover mounted on the top of the body in a thread manner and a fixing element attached to the bottom of the body to mount the valve disk on the disk mount.

4. The inflating valve as claimed in claim 3, wherein
the body further has at least one mounting post formed on and protruding from the disk mount; and
the valve disk further has at least one mounting hole defined through the valve disk and mounted respectively around the at least one mounting post on the body.

5. The inflating valve as claimed in claim 4, wherein the fixing element further has at least one mounting hole mounted respectively around the at least one mounting post on the body; and
the valve disk is squeezed between the disk mount of the body and fixing element.

6. The inflating valve as claimed in claim 5, wherein the valve disk has a bending groove defined in one side face of the valve disk adjacent to the mounting end to make the valve disk bendable at the bending groove.

7. The inflating valve as claimed in claim 6, wherein
the valve disk further has a first spring mount formed on a bottom of the valve disk;
the cap further has a second spring mount mounted on and protruding from an inner surface of the cap; and
the recoil member has two ends respectively connected securely to the first and second spring mounts on the valve disk and the cap.

8. The inflating valve as claimed in claim 7, wherein
the cap has a pin hole defined in the cap; and
the second spring mount is mounted detachably on the cap and has a mounting pin formed on and protruding from a bottom of the second spring mount and inserted securely into the pin hole in the cap.

9. The inflating valve as claimed in claim 8, wherein each spring mount has an annular groove defined in an end of the spring mount to hold one end of the recoil member inside.

10. The inflating valve as claimed in claim 1 further comprising a cover mounted on the top of the body in a thread manner and a fixing element attached to the bottom of the body to mount the valve disk on the disk mount.

11. The inflating valve as claimed in claim 10, wherein
the body further has at least one mounting post formed on and protruding from the disk mount; and
the valve disk further has at least one mounting hole defined through the valve disk and mounted respectively around the at least one mounting post on the body.

12. The inflating valve as claimed in claim 11, wherein the fixing element further has at least one mounting hole mounted respectively around the at least one mounting post on the body; and
the valve disk is squeezed between the disk mount of the body and fixing element.

13. The inflating valve as claimed in claim 1, wherein the valve disk has a bending groove defined in one side face of the valve disk adjacent to the mounting end to make the valve disk bendable at the bending groove.

14. The inflating valve as claimed in claim 1, wherein
the valve disk further has a first spring mount formed on a bottom of the valve disk;
the cap further has a second spring mount mounted on and protruding from an inner surface of the cap; and
the recoil member has two ends respectively connected securely to the first and second spring mounts on the valve disk and the cap.

15. The inflating valve as claimed in claim 14, wherein
the cap has a pin hole defined in the cap; and
the second spring mount is mounted detachably on the cap and has a mounting pin formed on and protruding from a bottom of the second spring mount and inserted securely into the pin hole in the cap.

16. The inflating valve as claimed in claim 15, wherein each spring mount has an annular groove defined in an end of the spring mount to hold one end of the recoil member inside.
